(19) United States
(12) Patent Application Publication
(10) Pub. No.: US 2008/0015287 A1
(43) Pub. Date: Jan. 17, 2008

(54) Process for the preparation of crumb rubber/asphalt blends

(76) Inventors: James R. Butler, Friendswood, TX (US); William Lee, Humble, TX (US)

Correspondence Address: FINA TECHNOLOGY INC, PO BOX 674412, HOUSTON, TX, 77267-4412, US

(21) Appl. No.: 10/966,969

(22) Filed: Oct. 15, 2004

(51) Int. Cl. C08L 23/00

(52) U.S. Cl. 524/64

(57) ABSTRACT

A method for preparing a homogeneous blend of asphalt and ground tire rubber. An asphalt base material is heated to a temperature sufficient to permit the stirring of the asphalt base material within a mixing vessel. A particulate crumb rubber component having a designated average particle size is added to the asphalt base material. The crumb rubber material can be partially devulcanized or partially depolymerized and may be accompanied by the incorporation of another rubber component, such as a ground styrene butadiene rubber. Zinc oxide is added to the asphalt base material. The mixture incorporating the zinc oxide is stirred for a period sufficient to provide for substantial solubilization of the crumb rubber within the asphalt base material to provide a blend which has a higher homogeneity than a corresponding blend of the same asphalt and particulate rubber components which is heated and stirred under the identical conditions, but without the addition of the zinc oxide.

### FIELD OF THE INVENTION

This invention relates to the preparation of asphalt crumb rubber blends and more particularly to the preparation of such blends in which the incorporation of crumb rubber into an asphalt base material at moderate temperatures is facilitated by the addition of zinc oxide.

### BACKGROUND OF THE INVENTION

It is a conventional practice to incorporate scrap rubber particles into an asphalt matrix material to form asphalt paving or sealing materials. Such scrap rubber particles are referred variously as ground tire rubber (GTR) or crumb rubber and can include materials recovered from tire carcasses, reclaimed tire treads and the like. The asphalt base material incorporating such crumb rubber particles can be of any suitable type such as derived from petroleum refining operations and include aliphatic and aromatic hydrocarbons and heterocyclic compounds, including asphaltenes and malthenes of fairly high molecular weight. Aggregate particles ranging from sand to crushed rock the size of perhaps ¼-½ inch can be incorporated into the asphalt base material. The asphalt binder aggregate concrete formulation can be used as a concrete base for roads. Alternatively, a blend of asphalt can be applied as a sealer coat on top of existing road paving. Such sealing coats typically may be of a thickness of ⅛-¼ inch and may incorporate aggregate materials, or relatively finely ground aggregate materials can be dispensed on the sealer coat while it is hot, immediately after its application or after allowing the sealer to set for a period of a few hours or days.

As noted above, crumb rubber particles can be incorporated into asphalt base materials with the addition of aggregate particles as described above. Often such crumb rubber particles include ground up styrene butadiene copolymers or other synthetic rubbers or can include natural rubbers. Usually, the rubbers as used in formulating tires have been vulcanized with a sulfur-based cross-linking agent to provide a rubber material of the desired characteristics. The crumb rubber reclaimed by grinding tire carcasses will be in the form of ground vulcanized rubber which incorporates the sulfur-based cross-linking agents employed in the original vulcanization process. When mixing the ground tire rubber with the asphalt base material, it has been a normal practice to heat the asphalt/crumb rubber mixture during the blending process to drive off sulfur from the asphalt/crumb rubber mixture. The crumb rubber can be devulcanized which may partially remove sulfur or at least reduce the presence of the sulfur employed in performing a cross-linking function. However, even then the crumb rubber/asphalt blend product is normally heated to a temperature in excess of 400° F., typically 450-500° F. in order to drive the sulfur off during the formation of the asphalt/crumb rubber mix. In addition to the crumb rubber derived from tire carcasses and the like, the rubber component mixed with the asphalt base material can include other rubbers which can be vulcanized, unvulcanized or partially devulcanized, such as natural rubber, isoprene rubber, butadiene styrene rubbers including styrene butadiene styrene block copolymers and ethylene propylene rubbers.

### SUMMARY OF THE INVENTION

In accordance with the present invention, there is provided a method for preparing a homogeneous blend of asphalt and ground tire rubber. In carrying out the invention, an asphalt base material is heated in a vessel to a temperature sufficient to permit the stirring of the asphalt base material within the mixing vessel. While the asphalt base material is stirred within the mixing vessel, a particulate crumb rubber component having a designated average particle size is added to the asphalt base material. The crumb rubber material can be partially devulcanized or partially depolymerized and its addition may be accompanied by the incorporation of another rubber component, such as a ground styrene butadiene rubber. In addition to the rubber component, zinc oxide is added to the asphalt base material. The asphalt/crumb rubber mixture incorporating the zinc oxide is stirred for a period sufficient to provide for substantial solubilization of the crumb rubber within the asphalt base material to provide a blend which has a higher homogeneity than a corresponding blend of the same asphalt base material and the same particulate rubber component with the same designated particle size which is heated and stirred under the identical conditions, but without the addition of the zinc oxide. At the conclusion of the stirring procedure, the crumb rubber and asphalt blend is recovered from the mixing vessel.

In a specific embodiment of the invention, the crumb rubber has an average particle size within the range of 0.1-1 millimeters and preferably within the range of 0.3-0.8 millimeters. The average particle size of the particulate crumb rubber in the crumb rubber/asphalt blend recovered from the mixing vessel has an average particle size which is less than the designated average particle size and preferably ranging from being completely soluble to a particle size of 0.05 millimeters, that is within the range of 0-0.05 millimeters. In a preferred embodiment of the invention, the particulate crumb rubber component is added to the asphalt base material in an amount of at least 5 wt. % and preferably in an amount within the range of 5-20 wt. % and more specifically 5-15 wt. %.

The zinc oxide is incorporated into the asphalt base material in an amount to provide a concentration of at least 0.1 wt. % of the composite amount of the asphalt base material and the particular crumb rubber component and more specifically in an amount within the range of 0.3-2 wt. %.

In a further aspect of the invention, the asphalt base material is heated to a temperature of no more than 400° F. while incorporating a particular crumb rubber component having an average particle size of 0.1-1 millimeters and zinc oxide. The crumb rubber/asphalt mixture is stirred at a temperature of no more than 400° F. for a period sufficient to provide for substantial solubilization of the crumb rubber within the asphalt base material to provide a blend in which the crumb rubber has an average particle size which is less than the original particle size and within the range of 0 (completely soluble) to 0.05 millimeters.

### DETAILED DESCRIPTION OF THE INVENTION

The present invention provides for the preparation of a relatively homogenous formulation of asphalt and ground tire rubber, hereinafter referred to as “GTR” or “crumb rubber,” under conditions in which the two components are mixed together under relatively moderate temperature conditions in the presence of zinc oxide. In typical blending operations, both the temperature of the asphalt base material and the particle size of the crumb rubber can be controlled in an attempt to obtain a homogeneous blend of these two materials. In general, unless extremely fine rubber particles are employed such as those obtained through cryogenic grinding, relatively high temperatures on the order of perhaps 450-550° F. are employed to arrive at a suitable homogenous blend. Even when partially devulcanized reclaimed ground tire rubber is employed, temperatures on the order of 450-500° F. or even higher are normally used to drive off sulfur from the GTR/asphalt blend. In addition to the need to drive off sulfur, the asphalt/GTR blend should be heated to a temperature sufficient to form a relatively homogeneous blend so that the blend is not “lumpy,” but is characterized by a relatively fine particle size distribution. In general, the relatively large particle size rubber components require heating to a higher temperature than those of relatively low particle size. However, even when the crumb rubber in the asphalt is finely ground, the need to eliminate sulfur can still dictate the use of temperatures in excess of 400° F. to drive off sulfur during the blending process.

From the foregoing, it will be recognized that the conventional wisdom in formulating crumb rubber into asphalt formulations is that the rubber should be finely ground, particularly when modest mixing temperatures are desired. Where larger particle size crumb rubber is employed, it is generally thought desirable to use higher mixing temperatures. While these higher mixing temperatures can accomplish the desired result of a homogenous mixture of crumb rubber and asphalt, the capital expenses associated with these more severe temperatures are also increased substantially. Regardless of the particle size of the crumb rubber and regardless of whether it has been subject to a devulcanization procedure, the requirement in the blending process is that the temperatures be sufficient to drive sulfur off from the crumb rubber/asphalt blend.

The present invention proceeds in a manner contrary to the conventional wisdom by employing crumb rubber which can be finely ground or of a relatively large particle size while achieving a homogenous mixture at a relatively low temperature of about 400° F. or less. Preferably, the temperature during solubilization of the crumb rubber within the asphalt base material is within the range of 350-400° F. during at least a predominant portion of the mixing time. This is accomplished though the use of zinc oxide as an additive to the asphalt/crumb rubber mixture. The zinc oxide preferably is added to the asphalt base material prior to the incorporation of the particulate crumb rubber component. However, the zinc oxide can be added concomitantly with or even subsequently to the incorporation of the particulate crumb rubber component into the asphalt base material.

The zinc oxide provides for a more homogeneous asphalt/crumb rubber blend than would otherwise be the case for the same blending procedure in terms of relative amounts of crumb rubber and asphalt, temperature, mixing time and shear rate, but without the use of zinc oxide. While applicants' invention is not to be limited by theory, it appears that the presence of zinc oxide during the blending procedure acts to trap the sulfur present in the crumb rubber component and prevent it from entering into or otherwise interfering with the reaction of the rubber component in the asphalt base material. Regardless of the manner in which the zinc oxide functions, it permits the blending operation to be carried out at a relatively low temperature range, within the range of 350-400°, while achieving a satisfactorily low particle size for the crumb rubber in the final rubber/asphalt blend.

In carrying out the invention, the crumb rubber may be added to the asphalt base material in any suitable amount consistent with industry standards. The crumb rubber component, which, in addition the ground tire rubber, can also include a more elastomeric component such as styrene butadiene rubber, normally will be added to the asphalt base material in an amount of at least 5 wt. % based upon the asphalt base material. Although higher amounts of the particular rubber component can be used, it will normally be maintained within the range of 5-20 wt. % and preferably within the range of 5-15 wt. %. The zinc oxide is incorporated into the asphalt base material in an amount of at least 0.1 wt. % and preferably in an amount within the range of 0.2-2 wt. %. In most cases it will be preferred to employ the zinc oxide in an amount within the range of 0.3-1 wt. %, specifically about 0.5 wt. % of the asphalt base material, incorporating the crumb rubber component.

The crumb rubber incorporated into the asphalt base material will normally have an average particle size of about 0.1-1 millimeters and more preferably, an average particle size within the range of about 0.3-0.8 millimeters. At the conclusion of the blending process, the average particle size of the crumb rubber in the crumb rubber/asphalt blend will have a reduced particle size, normally within the range of about 0 (completely soluble) to 0.05 millimeters.

The mixing time during which the asphalt/crumb rubber mixture is stirred during the blending operation will normally be within the range of about 4-48 hours, after which the crumb rubber and asphalt blend is recovered from the mixing chamber. The mixing time will vary somewhat depending upon the shear rate and the temperature at which the blending is carried out. As noted previously, it is preferred to blend the asphalt/crumb rubber mixture at a temperature within the range of 350-400° F. Where the temperature is near the upper end of this range, the mixing time may be somewhat shorter than is the case in which the temperature is within the lower part of the 350-400° F. range. During the blending operation, the asphalt/crumb rubber blend can be mixed at any suitable shear rate consistent with industry standards. Normally a relatively high shear rate represented by a mill clearance of<2 mm will be employed, but is not necessary. The mixing time will depend, to some extent, upon the shear rate as well as the temperature, a higher shear rate permitting a somewhat reduced mixing time before the asphalt/crumb rubber blend is recovered from the mixing chamber.

The average particle size of the crumb rubber in the final mixture preferably is no more than one-half of the average particle size of the crumb rubber when it is incorporated into the asphalt base material. Stated otherwise, the crumb rubber/asphalt blend containing zinc oxide is heated and stirred for a time sufficient to reduce the size of the particulate crumb rubber in the final blend to no more than one-half of its original size. Preferably the crumb rubber in the final asphalt/crumb rubber blend is reduced by at least two-thirds so that the average particle size is no more than one-third of the original average particle size. In a preferred embodiment of the invention, 20-40 mesh crumb rubber is originally incorporated into the asphalt base material providing an original size ranging from about 0.4 to about 0.8 millimeters, with an average particle size of about 0.6 millimeters. Preferably the average particle size of the crumb rubber remaining in the asphalt/crumb rubber mixture at the conclusion of the blending procedure will be about 0.05 millimeters or less.

In experimental work respecting the present invention, a 120/150 penetration grade feedstock was employed to produce an AC15-5TR seal coat. The production of the seal coat product was prepared by milling ground tire rubber containing a styrene butadiene styrene rubber component into 120/150 penetration asphalt blendstock in an amount of 5% rubber. The ground tire rubber and styrene butadiene styrene co-component were added into the 120/150 penetration asphalt blendstock separately; the crumb rubber as a 20-40 mesh ground component and the SBS as an 8 mesh non-vulcanized rubber. After heating the component with stirring, the resultant asphalt/rubber concentrate had a heterogeneous component in which the rubber additive occurred as “lumps” in the asphalt base material. The lumpy rubber/asphalt concentrate material was treated with 0.5 wt. % of zinc oxide and then blended at a high shear rate of 2000 RPM at a temperature of 400° F. for a period of one hour. At the conclusion of the milling procedure, the treated sample was filtered and tested. The particle size of the milled rubber in the final product was reduced to a desired value within the range of about 0-0.05 millimeters. As indicated by this experimental work, although it is preferred to incorporate the zinc oxide prior to or at the same time as the incorporation of the particulate crumb rubber component, the crumb rubber/asphalt blend can be formed first with zinc oxide added later to still produce good distribution of the rubber within the asphalt to provide a final product which is homogenous and has satisfactory penetration characteristics.

As indicated previously, the final product can be effectively used as a seal coat over an existing road material of Portland cement concrete or asphalt cement. The seal coat normally will be provided or distributed on the road base at a thickness of about ⅛ inch-¼ inch. The mixture of crumb rubber and asphalt base material may be employed as the final seal coat or subsequent to application to the road base material; an aggregate having a particle size of about 0.1 inches-0.5 inches may be spread over the top of the seal coat.

Having described specific embodiments of the present invention, it will be understood that modifications thereof may be suggested to those skilled in the art, and it is intended to cover all such modifications as fall within the scope of the appended claims.

We claim:

1. A method for preparing a homogenous ground tire rubber and asphalt blend comprising:
(a) heating an asphalt base material in a vessel to a temperature sufficient to permit the stirring of the asphalt base material within said vessel;
(b) stirring said asphalt base material and adding to said asphalt base material a particulate crumb rubber component having a designated average particle size;
(c) adding zinc oxide to said asphalt base material;
(d) stirring said asphalt crumb rubber mixture at a temperature and for a period sufficient to provide for substantial solubilization of said crumb rubber within said asphalt base material to provide a blend of said asphalt base material and said crumb rubber which has a higher homogeneity than a corresponding blend of said asphalt base material and said particulate crumb rubber of the same designated particle size which is heated and stirred under the same conditions as recited herein but without the addition of zinc oxide; and
(e) recovering said crumb rubber and said asphalt blend from said vessel.

2. The method of claim 1 wherein said zinc oxide is added to said asphalt base material prior to the incorporation of said particulate crumb rubber component into said asphalt base material.

3. The method of claim 1 wherein said zinc oxide is added to said asphalt base material concomitantly with or subsequent to the incorporation of said particulate crumb rubber component into said asphalt base material.

4. The method of claim 1 wherein said crumb rubber has an average particle size within a range of 0.1-1 millimeters.

5. The method of claim 4 wherein said crumb rubber has an average particle size within a range of 0.3-0.8 millimeters.

6. The method of claim 5 wherein the average particle size of said particulate crumb rubber of the crumb rubber and asphalt blend recovered in subparagraph (e) has an average particle size which is less than the designated average particle size and is within a range of 0-0.05 millimeters.

7. The method of claim 1 wherein said stirring of said crumb rubber and asphalt base material takes place at a temperature within a range of 350-400° F.

8. The method of claim 1 wherein said asphalt crumb rubber mixture is stirred for a period of about 4-48 hours prior to recovery of said crumb rubber and asphalt blend.

9. The method of claim 1 wherein said particulate crumb lubber component is added to said asphalt base material in an amount of at least 5 wt. % based upon said asphalt base material

10. The method of claim 9 wherein said particulate crumb rubber component is incorporated into said asphalt base material in all amount within a range of 5-20 wt. % of said asphalt base material.

11. The method of claim 10 wherein said crumb rubber component is added to said asphalt base material in an amount within a range of 5-15 wt. % of said asphalt base material.

12. The method of claim 1 wherein said zinc oxide is incorporated into said asphalt base material in an amount of at least 0.1 wt. % of the composite amount of said asphalt base material and said particulate crumb rubber component.

13. The method of claim 12 wherein said zinc oxide is incorporated into said asphalt base material in an amount within a range of 0.1-2 wt. % of the composite amount of said asphalt base material and said particulate crumb rubber component.

14. (canceled)

15. The method of claim 10 wherein said zinc oxide is incorporated into said asphalt base material in an amount of about 0.5 wt. % of the composite amount of said asphalt base material and said crumb rubber component.

16. A method for preparing a homogenous ground tire rubber and asphalt blend comprising:
(a) heating an asphalt base material in a vessel to a temperature of no more than 400° F. sufficient to permit the stirring of the asphalt base material within said vessel;
(b) stirring said asphalt base material and adding to said asphalt base material a particulate crumb rubber component having an average particle size within a range of 0.1-1 millimeters;
(c) adding zinc oxide to said asphalt base material;
(d) stirring said asphalt crumb rubber mixture at a temperature of no more than 400° F. and for a period sufficient to provide for substantial solubilization of said crumb rubber within said asphalt base material to provide a blend of said asphalt base material and said crumb rubber having an average particle size which is no more than one-third of the first recited average particle size; and
(e) recovering said crumb rubber and said asphalt blend from said container.

17. The method of claim 16 wherein said stirring of said crumb rubber and asphalt base material takes place at a temperature within a range of 350-400° F.

18. The method of claim 16 wherein said asphalt crumb rubber mixture is stirred for a period of about 4-48 hours prior to recovery of said crumb rubber and asphalt blend.

19. The method of claim 16 wherein said crumb rubber component in paragraph (d) has an average particle size within a range of 0 (completely soluble) to 0.05 millimeters.

20. The method of claim 16 wherein said particulate crumb rubber component is added to said asphalt base material in an amount of at least 5 wt. % based upon said asphalt base material

21. The method of claim 20 wherein said particulate crumb rubber component is incorporated into said asphalt base material in an amount within a range of 5-20 wt. % of said asphalt base material.

22. The method of claim 20 wherein said crumb rubber component is added to said asphalt base material ill an amount within a range of 5-15 wt. % of said asphalt base material.

23. The method of claim 16 wherein said zinc oxide is incorporated into said asphalt base material in an amount of at least 0.1 wt. % of the composite amount of said asphalt base material and said particulate crumb rubber component.

24. The method of claim 20 wherein said zinc oxide is incorporated into said asphalt base material in an amount of 0.3-1 wt. % of the composite amount of said asphalt base material and said crumb rubber component.

25. The method of claim 16 wherein said zinc oxide is added to said asphalt base material prior to the incorporation of said particulate crumb rubber component into said asphalt base material.

26. The method of claim 16 wherein said zinc oxide is added to said asphalt base material concomitantly with or subsequent to the incorporation of said particulate crumb rubber component into said asphalt base material.
